(19) United States
(12) Patent Application Publication
(10) Pub. No.: US 2003/0164335 A1
(43) Pub. Date: Sep. 4, 2003

(54) Method for high throughput separations in microfluidic systems using small particles

(76) Inventors: Jay W. Grate, West Richland, WA (US); Cindy Bruckner-Lea, Richland, WA (US); Darrell Chandler, West Richland, WA (US); David A. Holman, Las Vegas, NV (US)

Correspondence Address: Douglas E. McKinley, Jr., McKinley Law Office, P.O. Box 202, Richland, WA, 99352, US

(21) Appl. No.: 10/132,498

(22) Filed: Apr. 24, 2002

Related U.S. Application Data
(63) Continuation-in-part of application No. 09/177,902, filed on Oct. 23, 1998.

(51) Int. Cl. B01D 15/00

(52) U.S. Cl. 210/660

(57) ABSTRACT

A method for manipulating small particles in a microfluidic system wherein a fluid flow through a tolerance of the microfluidic system is used to capture large particles, which are then used, in turn, to capture small particles.

### CROSS-REFERENCE TO RELATED APPLICATIONS

This is a Continuation in Part of U.S. patent application Ser. No. 09/177,902 filed Oct. 23, 1998, now U.S. Patent ______.

### STATEMENT REGARDING FEDERALLY SPONSORED RESEARCH OR DEVELOPMENT

This invention was made with Government support under Contract DE-AC0676RL01830 awarded by the U.S. Department of Energy. The Government has certain rights in the invention.

### BACKGROUND OF THE INVENTION

As used herein, renewable surface separations or sensing refers to systems wherein a column or passageway on a chip is repeatedly packed and unpacked with particles providing new particle surfaces for each use. As used herein,“particles” includes, but is not limited to, irregular and regular shapes, made of materials such as plastics, polymers, hydrogels, metal oxides, glass, ceramics, metals, and liposomes. “Particles” also include, but are not limited to, natural materials such as cells, viruses, bacteria, minerals, protein complexes, and the like. “Regular shapes” include, but are not limited to, beads and microspheres. The use of particles as the foundation for chemical or biochemical interactions has a long history in the field of separation science, and the use of particles is now widespread in bioanalytical separations and processes. Particles are also commonly used in other analytical techniques, for example in sensing methods. As these techniques have evolved, the use of particles has been incorporated into a wide variety of systems.

For example, the jet ring cell introduced by Ruzicka captures beads at the end of a tube in contact with a planar surface. A leaky tolerance between the tube end and the surface allows fluid flow but restricts the passage of beads. The term “tolerance” is used herein to describe a gap between parts of a microfluidic system that is designed to allow the passage of fluid, yet to restrict the passage of beads or particles used in the system. Beads can be removed from the cell either by reversing the fluid flow or lifting the tube away from the surface. Flow cells have also been developed that use a rod or piston to intersect a flow path with a tolerance, thereby allowing fluid flow past the rod but again preventing the passage of beads. The piston can be withdrawn from the flow path by translation along the axis of the rod to release beads.

Flow cells have also been developed where a rod intersects a flow path permanently, allowing fluid flow past the rod but preventing the passage of beads. The beads are removed from the flow cell by reversing the flow. The capture of beads in a “lab-on a valve” systems works in this way. A rotating rod design has been developed in which a rod with an angled end restricts bead passage when in one position, and releases the beads when rotated 180 degrees. Frit restricted designs have been introduced that have one inlet and two outlets, one outlet containing a frit that prevents bead passage. Fluid flow through the frit outlet captures beads and fluid flow through the other outlet releases the beads.

There also exists prior art on “suspension arrays”. The development of “suspension arrays” involves the use of biointeractive particles or beads that are contacted with the sample to selectively collect biomolecules of interest. The beads are collimated in a flow cytometry system and interrogated with lasers one at a time. Fluorescent tags captured on the beads can be measured, for example. In multiplex analyses, several types of optically encoded beads are mixed with the sample, followed by reading the beads one at a time, using the optical encoding scheme to identify which type of bead, i.e. which bioselective surface, is being read. In this approach, fresh beads with fresh interactive surfaces are used for each sample.

Renewable surface separations and sensing typically work with particles from 10 to 150 microns in diameter for nonmagnetic flow cells for particle trapping. By contrast, flow cytometry for suspension arrays is conventionally carried out using 5-6 micron diameter nonmagnetic optically-encoded beads. Flow cytometry, however, is not restricted to optically-encoded beads. Any type of particle will generate a flow cytometry signal, is particularly useful for multiplexed detection. Other particles which may be advantageously employed in flow cytometry include intact cells, for example, which may be from 1 -10 microns in diameter. This size falls into a range that is not typically encountered in microfluidic particle trapping systems. As used herein, the term “microfluidic” refers to systems and apparatus capable of manipulating fluids in sub-millimeter volumes, which also includes systems having the capability to process both sub-milliliter and larger volumes.

A wide variety of microfluidic systems have been described. For example, microfluidic systems are described in O. Egorov, M. J. OHara, J. W. Grate, D. P. Chandler, F. Brockman, C. J. Bruckner-Lea, “Systems for Column-Based Separations, Method of Forming Packed Columns, and Method of Purifying Sample Components”, U.S. Pat. No. 6,136,197, Oct. 24, 2000, O. B. Egorov, M. J. O'Hara, J. Ruzicka, and J. W. Grate, “Sequential Injection Renewable Separation Column Instrument for Automated Sorbent Extraction Separations of Radionuclides” Anal. Ch 71,345-352 (1999), C. J. Bruckner-Lea, M. S. Stottlemyre, D. A. Holman, J. W. Grate, Fred J. Brockman, and Darrell P. Chandler. Rotating Rod Renewable Microcolumns for Automated, Solid-Phase DNA Hybridization Studies” Anal. Chem. 72,4135-4141, (2000), and D. P Chandler, D. A. Holman, F. J. Brockman, J. W. Grate, and C. J. Bruckner-Lea, “Renewable Microcolumns for Solid Phase Nucleic Acid Separations and Analysis from Environmental Samples”, TrAC, Trends Anal. Chem., 9, 314-321, 2000.

Other microfluidic systems, and the uses of microfluidic systems in general, have also been described. For example, in the field of flow injection analysis, the manipulation of suspensions of interactive particles within microfluidic systems was demonstrated by Ruzicka, J.; Pollema, C. H.; Scudder, K. M.; Dep. Chem, U.W.S.W.A.U.S.A., in “Jet ring cell: a tool for flow injection spectroscopy and microscopy on a renewable solid support”, published in Anal. Chem. 1993, vol. 65, 3566-70. In this disclosure, a flow cell design for spectroscopic measurements of suspensions, the jet ring cell, was introduced. The cell exploits radial flow through a narrow ring-shaped gap to retain suspended particles within the detection region. This ring constitutes a detection volume of well-defined area from which the trapped particles can be instantaneously removed. The bed of particles forms a renewable surface, which can be probed by reflectance, fluorescence, or chemiluminescence using a microscope or optical fiber. The device is useful for microscopic study of cells, for automated immunoassays, and for preconcentration of analytes on sorbents with in situ spectroscopic detection. In conjunction with a fiber optic detection system, the jet ring cell becomes a component of a renewable chemical sensor system.

Ruzicka, J.; Dep. Chem, B.G.U.W.S.W.A.U.S.A., “Discovering flow injection: journey from sample to a live cell and from solution to suspension”, Analyst (Cambridge, U. K.) 1994,119, 1925-34, serves as an overview of the evolving field, where flow injection is described as an ever-expanding method, as new modifications are discovered such as flow injection cytoanalysis and the flow injection on renewable surfaces technique. In this review, supplemented with 40 references, predictions for the future of the field are given, with comment on how research was actually being conducted.

Pollema, C. H.; Ruzicka, J.; Department of Chemistry, U.o.W.S.W.A.U.S.A., “Flow Injection Renewable Surface Immunoassay: A New Approach to Immunoanalysis with Fluorescence Detection”, Anal. Chem. 1994,66, 1825-31 describes a method of carrying out heterogeneous immunoassays automatically, using a flow injection technique on a renewable surface. As described in the paper, flow injection renewable surface immunoassay (FIRSI) relies on the use of a minute amount of beads to form a reactive surface, which is interrogated by fluorescence spectrometry. Following the assay, online regeneration normally used in flow based immunoassays is avoided by fluidically removing the spent reactive surface and replacing it with a new layer of beads. This allows the monitoring of antibody-antigen binding at its early stages, dramatically increases the sampling frequency of a serial assay, and eliminates the problems associated with a decrease in surface reactivity caused by repetitive use. A model system utilizing anti-mouse IgG I-coated beads and mouse IgG I protein is used to characterize the method with respect to reproducibility, flow rate, contact time, and the amount of beads.

Egorow, O.; Ruzicka, J.; Dep. Chem, U.W.S.W.A.U.S.A_ “Flow injection renewable fiber optic sensor system. Principle and validation on spectrophotometry of chromium (W)”, Analyst (Cambridge, U. K) 1995, 120, 1959-62. describes a renewable chemical sensor system using minute amounts of beads on which the reagent is adsorbed and the analyte becomes preconcentrated and monitored. Spent beads are discharged after each use and the sensor surface is renewed by injecting a new portion of fresh bead suspension.

Ruzicka, J.; Department of Chemistry, B.G.U.o.W.S.W.A.U.S.A., “Flow injection-renewable surface techniques”, Anal. Chim. Acta 1995,308, 14-19, describes a systems wherein minute amounts of polymer particles, such as those used in chromatography, are handled by a sequential injection system equipped with a jet ring cell, with the aim to form reactive and disposable surfaces. The advantages and applications of this technique for chemical sensors and in instrumental analysis are discussed based on the background of experiments carried out on fluorescence-based immunoassay and reflectance-based solid state colorimetry.

In Mayer, M.; Ruzicka, J.; Department of Chemistry, U.o.W.S.W.A.U.S.A., “Flow Injection Based Renewable Electrochemical Sensor System”, Anal. Chem. 1996, 68, 3808-3814, a class of electrochemical sensors is proposed utilizing electrically conducting beads to form a disposable electrode, as well as nonconducting beads to form renewable layers of immobilized enzymes. The concept, aimed to prevent fouling, is tested on an amperometric sensor coupled to nonconducting beads with different immobilized oxidases, e.g., galactose, lactate, alc., or glucose oxidase, the latter 2 being used to detect alcohol and glucose, respectively, in samples of beer and wine. Glucose oxidase was also immobilized on conducting glassy carbon particles to explore the performance of a biosensor where both enzyme and electrode can be automatically renewed in <1 min.

In Willumsen, B.; Christian, G. D.; Ruzicka, J.; Department of Chemistry, U.o.W.S,W.A.U.S.A., “Flow Injection Renewable Surface Immunoassay for Real Time Monitoring of Biospecific Interactions”, Anal. Chem. 1997,69, 3482-3489, an automated system for performing rapid immunoassay, kinetic measurements, and affinity ranking of biomolecular interactions using fluorescence-labeled ligands is described. The automated renewal of solid phase for each measurement, which avoids the need for regeneration of the sensing surface, is set forth. This system-flow injection renewable surface inummoassay (FIRSI)—is used for determining rate constants for an antibody/antigen interaction and for affinity ranking of several related antigens against one antibody.

In Ruzicka, J.; Ivaska, A.; Department of Chemistry, U.o.W.S.W.A.U.S.A., Bioligand Interaction Assay by Flow Injection Absorptiometry, Anal. Chem. 1997, 69, 5024-5030, a technique for the study of bioligand interactions based on combining flow injection on renewable surfaces with UV-visible absorptiometry is described. The concept is demonstrated by monitoring the binding of various proteins to protein G and the binding of various insulin analogs to a monoclonal anti-insulin antibody, thus providing a comparison with the performance of surface plasmon resonance (SPR)-based techniques.

In Holman, D. A.; Christian, G. D.; Ruzicka, J.; Center for Process Analytical Chemistry Department of Chemistry, U.o.W.S.W.A.U.S.A., “Titration without Mixing or Dilution: Sequential Injection of Chemical Sensing Membranes”, Anal. Chem.1997, 69, 1763-1765, a miniaturized titration was developed using beads 35 mm in diameter as semisolid aqueous titrant retained in a nonaqueous sample stream. Agarose beads with internally bound pH indicator served as a pH sensing membrane material swollen with aqueous NaOH titrant. The indicator monitored the remaining titrant within the agarose beads during perfusion with H2S04 in 1-butanol samples. Irreversible reaction of 2 mg bead layers was made possible by automated packing and disposal in a flow cell.

Dockendorff, B.; Holman, D. A.; Christian, G. D.; Ruzicka, J.; Department of Chemistry, C.f.P.A.C.U.o.W.S.W.A.U.S.A., “Automated solid phase extraction of theophylline by sequential injection on renewable column”, Anal. Commun. 1998,35, 357-359. describes a miniaturized and fully automated solid phase extraction system developed based on sequential injection onto a renewable microcolumn of an ion exchanger.

Ruzicka, J.; Department of Chemistry, U.o.W.S.U.S.A., “Bioligand interaction assay by flow injection absorptiometry using a renewable biosensor system enhanced by spectral resolution”, Analyst, (Cambridge, U.K.) 1998,123, 1617-1623, asserts that conventional biosensors, such as those based on surface plasmon resonance, lack spectral resolution and employ a permanent sensing layer that needs to be activated and also regenerated after use. In contrast, scanning of the UVNIS spectrum of agarose beads, trapped in a specially designed flow cell, allows real time monitoring of labeled and unlabeled biomolecules with spectral resolution on a surface that can be automatically renewed by microfluidic manipulation. Agarose beads are identical with column materials used in affinity chromatography and therefore are readily available, derivatized with a wide choice of bioligands.

Hodder, P. S.; Ruzicka, J.; Department of Chemistry, U.o.W.S.W.A.U.S.A-, “A flow injection renewable surface technique for cell-based drug discovery functional assays”, Anal. Chem. 1999, 71, 1160-1166 describes a novel flow injection-renewable surface (FI-RS) technique for the execution of automated pharmacologically-based assays on living cells. Cells are attached to microcarrier beads, which serve as the disposable and renewable surface with which the assay is performed. The feasibility of this FI-RS technique is demonstrated by performing a functional assay using Chinese hamster ovary cells transfected with the rat muscarinic receptor (MI). The intracellular calcium elevation resulting from the agonist-receptor interaction is measured via a calcium-sensitive fluorescent probe (fura-2) and a fluorescence microscope photometry system.

These prior art microfluidic systems focus on single analyte or single particle type analysis in a serial fashion. As such, there exists a need to extend renewable surface methods to multiplexed analysis. Further, when considering the use of small particles, such as those falling in the 5-6 micron size, all of these prior art microfluidic systems suffer from a common drawback. The tolerances in these systems are universally too large to restrict the passage of these small particles, and still allow the passage of fluids. This drawback is, in part, a result of the extreme expense of machining the fine tolerance in the parts of these systems that is required for such small particles. Accordingly, there is a need for flow cell designs that can trap and release 5-6 micron particles, for example, to hold the particles during sample and/or reagent treatments prior to delivery to a flow cytometer measurement system, that does not require the costly machining associated with constructing systems having such fine tolerances.

### BRIEF SUMMARY OF THE INVENTION

Accordingly, it is an object of the present invention to provide a method for trapping and releasing small particles in microfluidic systems wherein the particle size is smaller than the tolerance of the microfluidic system. It is a further object of the present invention to provide such a method without the need for expensive machining in microfluidic systems necessary to fashion such tolerances. It is a further object of the present invention to provide a method for trapping and releasing small particles in existing renewable surface microfluidic systems, which have tolerances greater than the diameter of small particles.

These and other objects of the present invention are accomplished by an improved method for manipulating small particles in a microfluidic system wherein at least one tolerance of the microfluidic system is greater than the size of the small particles. The improvement in one aspect involves the step of providing a layer of large particles that are sufficiently small to capture the small particles within or above the large particles, but insufficiently small to escape through the tolerances within the microfluidic system. In one aspect of the present invention, the layer of large particles is provided as a mixture with the small particles in a fluid flow through the microfluidic system. In another aspect of the present invention, the layer of large particles is formed by providing a fluid flow in the microfluidic system into a region of the microfluidic system having the tolerance. The large particles are then stopped by the tolerance, and the fluid flow is allowed to pass through the tolerance. Subsequently, small particles are introduced into the fluid flow, thereby trapping the small particles within or above the large particles, and still allowing the fluid flow to pass through the tolerance. While it is generally preferred in certain applications of the improved method of the present invention that the small particles are provided as having a diameter of between about 5 and 6 microns and the large particles are provided as having a diameter of about 20 microns, those having skill in the art will readily appreciate that the method of the present invention is broadly applicable on any scale, and should be understood to encompass such differing scales.

As will further be apparent to those having skill in the art, the present invention is broadly applicable in a variety of microfluidic systems, including, without limitation, those described and used in the references discussed in the background portion of this specification. Accordingly, all references cited herein are hereby incorporated into this specification in their entirety.

Embodiments of the present invention can further be operated with a vast number of differing particles, as will be appreciated by persons of ordinary skill in the art. While not meant to be limiting, example particles include Sr-resin, TRU-resin, and TEVA-resin, all of which can be obtained from ElChrom Industries, Inc., of Darien, Ill. Sr-resin, TRU-resin, and TEVA-resin can be used for, for example, selectively retaining radioactive materials. Specifically, Sr-resin can selectively retain strontium, TRU-resin can selectively retain americium, and TEVA-resin can selectively retain technetium.

Additional example particles include, but are not limited to, glass, Sepharose, polystyrene, Tepnel, Qiagen, zirconium, hydroxyapatite, POROS, PEG-PS, and PS the last three of which are made by PerSeptive are materials suitable for separating biological materials. Certain particles are materials for separating nucleotide fragments (e.g., nucleic acid, DNA, RNA or combinations thereof) based upon a sequence of the fragments. For example, and not meant to be limiting, Tepnel Life Sciences sells polymeric micro-beads which are covalently linked to specific oligonucleotide capture probes. Such micro-beads can be utilized for selective purification of nucleic acid fragments from a biological sample. For purposes of interpreting this disclosure and the claims that follow, the term “nucleic acid” is defined to include DNA nucleotides and RNA nucleotides, as well as any length polymer comprising DNA nucleotides or RNA nucleotides. Biological materials include but are not limited to viruses, cells for example prokaryote, eukaryote, proteins, peptides, biomolecules, and biopolymers. Also included are particles for capture, sensing, or purification of metals, ions, and chemicals.

### DRAWINGS

FIG. 1 is a schematic of the rotating rod renewable microcolumn flow cell used in experiments conducted to demonstrate the present invention. FIG. 1(A) shows with the beveled rod in the trap position, particles larger than the leaky tolerance collect in the microcolumn as fluid flow continues through the outlet port. To flush particles to waste, the beveled rod is rotated 180 degrees as shown in FIG. 1(B). The top-layered renewable filter strategy of FIG. 1(C) requires forming a first layer of “filter” particles that are larger than the leaky tolerance of the flow cell, followed by trapping particles smaller than the leaky tolerance. The mixed bed renewable filter shown in FIG. 1(D) requires pre-mixing the larger- and small-diameter particles off-line prior to injection into the renewable surface flow cell.

### DETAILED DESCRIPTION OF THE INVENTION

The forgoing Summary of the present invention describes the invention in its broader aspects, including its ability to utilize a broad range of particles in a wide variety of microfluidic systems. To better illustrate the operation and advantages of the present invention, a series of experiments were performed as described below. As those having skill in the art will recognize, in implementing experiments of this nature, it becomes necessary to select a specific microfluidic system and a specific particle material. The selection of the exemplary particles and the specific microfluidic system in the following examples should therefore in no way be seen as limiting the invention in its broader aspects, and are only included for their illustrative value. As will be readily apparent to those having skill in the art, a broad range of microfluidic systems can be enhanced by the present invention, and broad variety of differing particle materials can similarly be utilized according to the needs of a particular situation. Indeed, the entire range of microfluidic systems and particles known by those having skill in the art, including without limitation all forms of sequential injection renewable surface columns (SI-RSC) such as fiber-optic sensing, radiochemical separations and sensors, competitive immunoassays, electrochemical biosensors, whole-cell assays, protein-protein interactions, and nucleic acid analysis, with flow cell geometries ranging from porous frits, moveable capillaries, barriers and microfabricated structures should therefore be recognized as falling within the spirit and scope of the claims at the concluding portion of this specification. The experiments demonstrated several aspects of the present invention by demonstrating a simple yet elegant method for forming a renewable filter within a microfluidic system. The following methods are common to all experiments described herein.

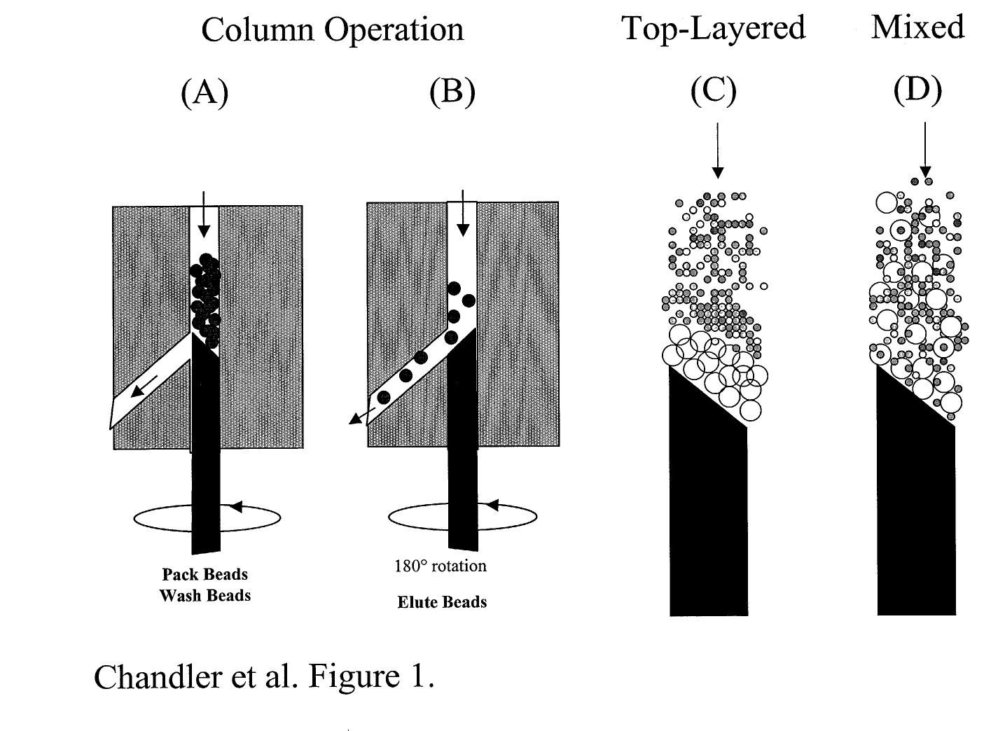

The fluidic system was a standard sequential injection system (FiaLab 3000, Alitea, USA) consisting of a 1 ml syringe pump (Cavro, Sunnyvale, Calif.), 10-port selection valve (Valco, Cheminert, Houston, Tex.) and a holding coil. All tubing was 1 mm ID FEP Teflon (Upchurch, Oak Harbor, Wash.). Reagents were aspirated through the selection valve into a holding coil, and then delivered to a rotating rod renewable microcolumn (17) as shown schematically in FIG. 1. The flow cell was machined from FEP fluoropolymer with a 0.89 mm diameter nickel rod beveled to 45° angle at one end. The beveled rod was rotated within the flow cell using an Arsape AM1524 stepper motor and 14:1 gear train (Donovan Micro-Tek, Inc., Simi Valley, Calif.). The fluidic system and rotating rod were controlled with a laptop computer and in-house system control software written in Microsoft Visual C++ with a LabWindows/CVI (National Instruments, Austin, Tex.) user interface.

A Luminex 100 flow cytometer served as the detector for all studies, including the quantification of bead capture efficiency in the rotating rod microcolumn (below). The Luminex 100 is equipped with a 635 nm diode classification laser and a 532 frequency-doubled diode reporter laser. Sheath fluid is passed through a 200×200 μm flow channel at 90 μL s⁻¹, with a 20-25 μm diameter sample stream. Polystyrene packing beads (above) were therefore selected based on the dimensions of the sample stream in the detector. Samples were injected at 60 μL min⁻¹, with the cytometer set to count a specific number of positive events for each 5.6 μm bead type. 100 events per bead type were typically analyzed unless otherwise noted, with injection volumes ranging from 10-400 μL. A calibration run was performed with CAL1 and CAL2 calibration microspheres each day according to Luminex instructions. Bead suspensions were disaggregated by vortexing prior to sample injection into the flow cytometer. The flow cytometer was controlled from a Pentium-II PC, and all data analysis was performed on LMAT™ version 1.7 software (Luminex).

Coupling the flow cytometer to the renewable microcolumn system (FIG. 1A) occurred by ejecting beads from the rotating rod (FIG. 1B) into the sample tube on the Luminex instrument. For optimizing the bead injection method, the entire sample volume (400 μL) was counted. For model biological assays, the cytometer sample injection volume was fixed at 50 μL and the median fluorescent intensity (MFI) from the reporter channel was calculated from at least 100 positive events. For experiments with fluorescent reporters, the first 20 events were ignored (from 10³ injected beads) detected by the cytometer to account for bead carryover within the cytometer between individual analyses. At least five replicate tests were performed for each treatment (described below) and used to calculate an average MFI±standard deviation.

Several sets of bead-based reagents were used to develop and demonstrate the bead injection methods reported here. All bead concentrations were verified by counting bead slurries on a hemocytometer before use. For establishing bead injection and particle counting methods within the rotating rod system, we utilized 5.6 μm LABMAP™ carboxylated development microspheres from Luminex (Austin, Tex.) with or without polystyrene packing microspheres that were obtained from Bangs Laboratories, Inc. (Fishers, Ind.; 19.9±0.6 μm and/or 23.25±0.53 μm).

Several methods of column formation, perfusion and release were investigated (as described in the appropriate legends). Top-layering and mixed-bed concepts formed the basis of the fundamental bead trapping strategies described here, and are illustrated graphically in FIG. 1C and 1D. Briefly, the top-layering method involves forming a first layer of beads that are larger than the leaky tolerance of the rotating rod flow cell (e.g. 19.9 and/or 23.2 μm Bangs beads), followed by a second layer of beads that are smaller than the leaky tolerance (e.g. 5.6 μm Luminex beads). The mixed-bed method involved mixing the large and small particles off line (combining 5.6 and 19.9/23.2 μm particles) before delivering the combined bead slurry to the renewable microcolumn.

The number of 19.9 and 23.2 μm beads (alone or in combination) was fixed at 5×10⁴ total particles for these studies. A typical test-tube Luminex protocol involves 2500 colored 5.6 μm particles per assay for each analyte of interest. In order to develop bead injection methods for multi-analyte capture and detection, 10⁵ 5.6 μm beads were utilized, forming a renewable microcolumn which is equivalent to a 40-analyte (test-tube) binding assay. Optimizing the complete analytical method (i.e. column formation, release, and flow cytometer particle counting) required a systematic evaluation of particle concentration, elution, and injection volumes within the renewable microcolumn and flow cytometer detector. Once these parameters were understood and standardized (see Results), 5.6 μm bead trapping and release efficiency for different column packing strategies was measured by direct particle counting in the Luminex flow cytometer, ignoring particles larger than 5.6 μm. Calculations of bead capture efficiency were based on the total number of events that the Luminex instrument counted in the pack, wash and elution volumes; i.e. % Counted=C_{C}/(C_{P}+C_{W}+C_{C}) where C_{P}, C_{W} and C_{C} are the Luminex particle counts in the eluant from packing, wash and column elution steps, respectively.

Because the experiments sought to purposefully introduce “large” particles into the flow cytometer, an understanding of the behavior and particle counting efficiency of the cytometer in the presence of the large packing beads was required before the renewable microcolumn performance could be quantified (e.g. efficiency of column formation, analyte capture and detection). Initial studies of particle counting efficiency combined 10⁴ 19.9 μm packing beads with 10⁵ Luminex development microspheres in 400 μL volume (125 and 250 beads μL⁻¹, respectively), while varying the sample injection volume. There was an increase in total (5.6 μm) particle counts as the injection volume increased, but no noticeable difference in the consistency (SD) of particle counting (not shown). This result is attributed to better bead dispersion in the larger sample injection volume, even though the absolute bead concentration remained constant for all injection volumes. Because the counting efficiency was highly reproducible regardless of the injection volume, the cytometer injection volume was arbitrarily fixed at 50 μL for subsequent experiments.

To determine if the Bangs packing beads were influencing the detection of 5.6 μm particles (i.e. counting efficiency), the concentration of 5.6 μm development beads was varied in a 50 μL injection volume and they were counted in the presence or absence of 125 19.9 μm packing beads μL⁻¹. Importantly, the presence of 19.9 μm packing beads did not interfere with the detection (counting) of 5.6 μm beads, regardless of 5.6 μm bead concentration.

Finally, both the concentration of 19.9 μm and 5.6 μm beads were varied to estimate the best column ejection volume for the rotating rod device, prior to sample injection in the flow cytometer. Thus, a fixed number of 19.9 μm packing and 5.6 μm capture beads were maintained (5×10⁴ and 1×10⁵, respectively) but the total volume of bead solution was varied. Results confirmed that a 400 μL column elution volume was a reasonable and efficient volume in which to eject the renewable microcolumn prior to flow cytometer detection, with no statistical difference between 5.6 μm particle counting efficiency in the presence or absence of 19.9 μm particles (P=0.17, Student's t-test). From these studies, then, renewable microcolumn trapping and perfusion procedures were established to capture 5×10⁴ packing beads and 1×10⁵ 5.6 μm capture beads, elute the packed column in 400 μL, and inject (at least) 50 μL into the cytometer for particle counting and analyte detection.

Trapping 1-10 μm particles is a fundamental gap in sequential injection renewable separation column (SI-RSC) technology. To address this need, several renewable filter methods were developed and tested. Each method of particle trapping results in a different interstitial space or pore size within the renewable microcolumn. For example, forming a bed of 19.9 μm particles (FIG. 1C) results in interstitial spaces ranging from 3.1-8.3 μm (depending upon the precise packing geometry); the 5.6 μm top-layer then creates a filter with a nominal interstitial space of 0.9-2.3 μm diameter. Thus, the top-layering strategy described here should retain sample particulates >0.9 μm. In contrast, the mixed packing strategy (FIG. 1D) will create a renewable filter with a nominal interstitial space between 0.9 and 8.3 μm.

Table 1 shows the results for five renewable filter strategies for retaining 5.6 μm beads.

TABLE 1
Capture efficiency of 5.6 μm beads with various renewable
microcolumn packing strategies.

| | Packing bead | % Counted (±SD)^{a} | | |
|---|---|---|---|---|
| Strategy | diameter (μm) | Pack | Wash | Column |
| Top-layered | 19.9 | 0.4 ± 0.6 | 0.5 ± 0.5 | 99.1 ± 0.6 |
| Top-layered | 23.2 | 1.6 ± 0.8 | 0.5 ± 0.3 | 97.9 ± 0.6 |
| Top-layered^{b} | 19.9/23.2 | 0.6 ± 0.7 | 1.8 ± 0.9 | 98.1 ± 1.0 |
| Mixed | 19.9 | 1.5 ± 0.8 | 3.2 ± 2.3 | 95.3 ± 2.7 |
| Mixed | 23.2 | 6.9 ± 1.0 | 6.0 ± 1.9 | 87.0 ± 2.4 |

^{a}% Counted = C_{C}/(C_{P} + C_{W} + C_{C} ) where C_{P}, C_{W} and C_{C} are the 5.6 μm particle counts in the eluant from packing, wash and column elution steps, respectively. The entire injection or elution volume was counted for all experiments; 100 μL Pack, 200 μL Wash, 400 μL Column.
^{b}6 × 10³ of the 19.9 and 4 × 10³ of the 23.2 μm packing beads were mixed off-line before injection into the renewable microcolumn. 5.6 μm Luminex particles were then layered on top as shown in FIG. 1C.

The top-layering strategy was the most efficient 5.6 μm bead packing method, and increasing the packing matrix to 23.2 μm diameter beads led to an increase in 5.6 μm particle escape from the column. Based on these results, the 19.9 μm packing beads were then utilized in both top-layered and mixed approaches to investigate analyte capture efficiency in one-, two- and three-analyte binding and detection assays.

Renewable microcolumns were automatically formed in the rotating rod flow cell with both the top-layered and mixed packing strategies, utilizing 5×10⁴ 19.9 μm packing beads, 5×10⁴ Lumavidin-coated #111 beads, and 5×10⁴ carboxylated #173 beads. Packed columns were formed from a 100 μL bead injection volume, and the packed column was flushed from the flow cell in 400 μL. The Lumavidin bead bed contained approximately 1×10¹¹ biotin binding sites. The column (top-layered or mixed) was perfused with either 1 or 100 nM biotin-PE (3×10¹⁰ and 3×10¹² biotin molecules, respectively) according to the automated procedure outlined in Table 2

TABLE 2
Automated renewable microcolumn procedure for
one-step binding, multi-bead detection assay.

| | | Volume | Flow Rate |
|---|---|---|---|
| Description | Solution | (μL) | (μL s⁻¹) |
| Form column (rod in | Top-Layered^{a} | 100 | 10 |
| trap position) | Mixed^{b} | 200 | 10 |
| Perfuse with analyte | Biotin-PE^{c} | 50 | 2 |
| Wash column | PBS-Tween | 200 | 10 |
| Release colunmn to | | 400 | 100 |
| cytometer | | | |
| reverse flow | PBS-Tween | 400 | 100 |
| rotate rod to release | | | |
| flush column | | | 100 |
| Clean flow cell | PBS-Tween | 150 | 200 |

^{a}The top-layered protocol utilized 5 × 10⁴ Bangs 19.9 μm beads injected into the rotating rod microcolumn in 100 μL, followed by 100 μL of either 1 × 10⁵ 5.6 μm Lumavidin #111 beads, or a 50:50 mixture of 5 × 10⁴ Lumavidin #111 plus 5 × 10⁴ carboxylated #173 beads.
^{b}The mixed packing strategy utilized an identical number (and type) of beads, but the beads were pre-mixed off-line prior to injection into the rotating rod microcolumn.
^{c}Biotin-PE was diluted to 1 or 100 nM in PBS-Tween buffer before injection.

Fifty microliters of the ejected microcolumn (˜1000 packing, Lumavidin and carboxylated beads, respectively) was analyzed directly on the Luminex flow cytometer. For binding experiments under saturating conditions (100 nM biotin-PE), a 50 μL injection volume was utilized and a minimum of 100 events were counted for calculating an average MFI. For binding experiments under non-saturating conditions, the injection volume was varied so as to count a minimum of 5000 events for calculating the average MFI. The first 20 events were ignored for all MFI calculations, because the flow cytometer showed evidence of particle carryover between runs.

Results of these experiments are summarized in Table 3. The labeled target (biotin-PE) was reproducibly and consistently detected on the proper (selective) 5.6 μm bead regardless of bead injection method. The presence of 19.9 μm packing beads did not contribute to non-specific binding of the target to non-specific bead surfaces (including the carboxylated #173 beads). The efficiency of analyte capture did, however, show some dependence upon bead injection method and analyte concentration. Under non-saturating conditions (1 nM biotin-PE), for example, there was no significant difference in analyte capture and detection efficiency between the top-layered and mixed packing methods (Student's t-test; P=0.12). Under saturating conditions, however, the top-layered packing strategy resulted in significantly higher MFI values when both the carboxylated- and Lumavidin-coated 5.6 μm beads were immobilized in the column bed (P=0.003). The reason for these observations is unclear, but the results suggest that the best 5.6 μm bead trapping strategy may depend upon the specific type and concentration(s) of analyte(s) of interest.

TABLE 3
Biotin-PE capture efficiency^{a} in top-layered and mixed
renewable filters utilizing a 19.9 μm packing layer.

| Column | | | Mixed | | | |
|---|---|---|---|---|---|---|
| Bead | Top-Layered | | | | | Student's |
| Composition^{b} | Reporter^{c} | Lumavidin | Carboxy | Lumavidin | Carboxy | t-test (P) |
| Lumavidin | None | 3.0 ± 0.0 | 0.0 ± 0.0 | 1.0 ± 0.0 | 0.0 ± 0.0 | |
| Carboxy | None | 21.8 ± 25.5 | 14.0 ± 0.0 | 0.0 ± 0.0 | 15.4 ± 0.5 | |
| Lumavidin+ | None | 1.2 ± 0.4 | 14.0 ± 1.1 | 1.0 ± 0.4 | 14.8 ± 0.8 | |
| Carboxy | | | | | | |
| Lumavidin | 1 nM | 2431 ± 541 | 0.0 ± 0.0 | 3451 ± 410 | 0.0 ± 0.0 | 0.006 |
| Carboxy | 1 nM | 0.0 ± 0.0 | 16.0 ± 0.0 | 0.0 ± 0.0 | 16.0 ± 0.0 | |
| Lumavidin+ | 1 nM | 3524 ± 203 | 16.6 ± 1.2 | 3366 ± 223 | 15.0 ± 0.0 | 0.12 |
| Carboxy | | | | | | |
| Lumavidin | 100 nM | 17464 ± 212 | 0.0 ± 0.0 | 17681 ± 954 | 0.0 ± 0.0 | 0.68 |
| Carboxy | 100 nM | 0.0 ± 0.0 | 15.4 ± 0.5 | 0.0 ± 0.0 | 15.4 ± 0.5 | |
| Lumavidin+ | 100 nM | 17515 ± 616 | 16.8 ± 0.9 | 15109 ± 815 | 16.2 ± 0.8 | 0.003 |
| Carboxy | | | | | | |

^{a}Capture efficiency is reported as the average median fluorescent intensity (± SD) from five replicate experiments.
^{b}The Lumavidin-coated and carboxylated development spheres were optically encoded (Luminex colors #111 and #173 respectively), allowing for the simultaneous detection of biotin-PE binding (specific or non-specific) to the renewable microcolmn beads.
^{c}For 1 nM experiments, the cytometer was set to count 5000 events in the Lumavidin #111 window and the injection volume was varied up to 200 μL in order to ensure detecting 5000 events. At 100 nM analyte, the cytometer was set to count

The automated nucleic acid assay was modeled towards the capture and detection of polymerase chain reaction (PCR) products. Vegetative B. globigii cells were cultivated in trypticase soy broth (TSB; Difco) and genomic DNA isolated by bead mill homogenization. A 230 bp fragment was amplified from genomic DNA using primers Bg215f (5′ ACCAGACAATGCTCGACGTT) and Bg345r (5′ CCCTCTTGAAATTCCCGAAT). PCR amplification was carried out in 25 μl total volume, utilizing an MJ Research (Watertown, Mass.) Tetrad thermal cycler and 0.2 ml thin-walled reaction tubes. PCR products from multiple reactions were pooled, ethanol precipitated and quantified by UV spectrophotometry. Concentrated amplicons were labeled with Alexa-532 utilizing a Ulysses labeling kit according to the manufacturer's protocol (Molecular Probes, Eugene, Oreg.). The peptide nucleic acid (PNA) probe capture sequence (Biotin-OOO-CGCCTGCAATTTACAGC-CO₂H) was synthesized and HPLC-purified by PE Applied Biosystems (Foster City, Calif.). PNA was reconstituted in water, quantified by spectrophotometry according to the manufacturer's instructions, and coupled to Lumavidin-coated beads (#138) according to the standard Luminex protocol. Coupling efficiency for the beads used herein was 34.4% of available Lumavidin binding sites.

The automated nucleic acid capture and detection procedure is outlined in Table 4.

TABLE 4
Automated renewable microcolumn procedure for nucleic
acid capture and detection.

| | | Volume | Flow Rate |
|---|---|---|---|
| Description | Solution | (μL) | (μL s⁻¹) |
| Form column (rod in | Top-Layered^{a} | 100 | 10 |
| trap position) | Mixed^{b} | 200 | 10 |
| Rinse beads | SSC-Tween | 200 | 10 |
| Perfuse with denatured | | 50 | 0.5 |
| target DNA | | | |
| Wash beads | SSC-Tween | 100 | 0.5 |
| Release column to | | 300 | 100 |
| cytometer | | | |
| reverse flow | SSC-Tween | 300 | 100 |
| rotate rod to release | | | |
| flush column | | | 100 |
| Clean flow cell | SSC-Tween | 150 | 200 |

^{a}The top-layered protocol utilized 5 × 10⁴ Bangs 19.9 μm beads injected into the rotating rod microcolumn in 100 μL, followed by 100 μL of either 1 × 10⁵ 5.6 μm carboxylated #138 beads.
^{b}The mixed packing strategy utilized an identical number (and type) of beads, but the beads were pre-mixed off-line prior to injection into the rotating rod microcolumn.

Packed columns were formed as described above, except a 1×10⁵ Luminex #138 beads with attached PNA probe (above) rinsed the beads in hybridization buffer (SSC-Tween 20=150 mM NaCl, 15 mM sodium citrate, 0.02% Tween-20, pH 7.0) were used. One microgram of labeled B globigii PCR product was heat denatured at 95 C for 5 min off-line in the presence of 1 μg sheared salmon sperm DNA, and perfused over the column at 0.5 μL s⁻¹. Beads were washed with fresh hybridization buffer and eluted for detection in the flow cytometer as outlined in Table 4.

Specific DNA capture in the renewable filter also showed that the top-layered packing strategy resulted in significantly higher recover and detection of DNA than the mixed packing strategy (162±39 versus 90±20 average MFI; Student's t-test P=0.005). In the absence of salmon sperm DNA, capture and detection limits were identical (P=0.12), indicating that salmon sperm DNA was required in order to achieve specific hybridization with the PNA probe.

The model two-step binding assay utilized 5×10⁴ packing beads (19.9 μm) and 1×10⁵ Protein A #134 beads in both top-layered and mixed column formats according to the automated procedure outlined in Table 5.

TABLE 5
Automated renewable microcolumn procedure for
two-step binding, multi-bead detection assay.

| | | Volume | Flow Rate |
|---|---|---|---|
| Description | Solution | (μL) | (μL s⁻¹) |
| Form column (rod in | Top-Layered^{a} | 100 | 10 |
| trap position) | Mixed^{b} | 200 | 10 |
| Perfuse with analyte | 0.5 μg rabbit IgG or | 36 | 0.5 |
| | IgG + biotin-PE | | |
| Wash column | PBS-Tween | 200 | 10 |
| Perfuse with reporter | 0.5 μg Alexa 532 | 50 | 0.5 |
| antibody^{c} | goat anti-rabbit IgG | | |
| Wash column | PBS-Tween | 200 | 10 |
| Release column to cytometer: | | | |
| reverse flow | PBS-Tween | 400 | 100 |
| rotate rod to release | | | |
| flush column | | | 100 |
| Clean sample inlet | PBS-Tween | 100 | 200 |
| Clean flow cell | PBS-Tween | 150 | 200 |

^{a}The top-layered protocol utilized 5 × 10⁴ Bangs 19.9 μm beads injected into the rotating rod microcolumn in 100 μL, followed by 100 μL of either 1 × 10⁵ 5.6 μm Protein A beads, or a 50:50 mixture of 5 × 10⁴ Lumavidin #111 plus 5 × 10⁴ Protein A beads.
^{b}The mixed packing strategy utilized an identical number (and type) of beads, but the beads were pre-mixed off-line prior to injection into the rotating rod microcolumn, resulting in a 200 μL rotating rod bead injection volume.
^{c}Multi-analyte capture experiments were performed with the indicated volume of solution containing 14.1 ng μL⁻¹ Alexa 532 goat anti-rabbit IgG, 100 nM biotin-PE in PBS-Tween buffer.

In this case, the antigen was 0.5 μg IgG, representing the amount of antigen in a typical 2500 bead, batch reaction. To demonstrate an automated two-analyte capture and detection assay, rabbit IgG and biotin-PE were pre-mixed off line to make a solution of 14 ng μL⁻¹ rabbit IgG, 1 nM biotin-PE in PBS-Tween. The mixed-analyte solution was perfused over renewable microcolumns consisting of a 50:50 mixture of protein-A and Lumavidin beads. For these experiments, the reporter antibody was perfused over the column in a separate step, as outlined in Table 5. When 100 nM biotin-PE was added as a second “analyte”, it was pre-mixed off-line with the Alexa 532 goat anti-rabbit IgG and captured in the secondary antibody binding step.

The two-step binding assay was performed in the presence and absence of the biotin-PE reporter, and with or without Lumavidin-coated beads, as summarized in Table 6. As with the single-step binding system, analyte capture and detection efficiency was dependent upon the bead injection method. For example, the antibody model system showed no dependence on column packing strategy if Protein A beads were the only selective bead type in the column (P=0.32). The presence of Lumavidin-coated beads, however, resulted in significantly higher antibody capture and detection efficiency in the mixed column format (P<0.001). A similar dependence upon bead injection method occurred with the biotin-PE reporter system in the multi-functional bead column consisting of both Protein A and Lumavidin-coated beads (Table 6), and these results were not consistent with capture and detection efficiencies when only the Lumavidin-coated bead was immobilized in the renewable microcolumn (Table 5). The presence or absence of non-specific antigen (rat IgG) had no effect on capture and detection of rabbit IgG, so the mixed results reported here are not a function of non-specific antibody binding to the different selective (and non-specific) bead surfaces. Nevertheless, both the top-layered and mixed bead injection techniques reproducibly formed packed columns and specifically captured multiple analytes in multi-step binding procedures (Table 6), and these sample preparation procedures were easily coupled directly to multiplexed flow cytometry detection.

The biotin, antibody and DNA model binding assays were combined into a single capture and detection experiment to illustrate the potential for multi-analyte binding and detection in the renewable filter. A packing layer of 19.9 μm Bangs beads was deposited in the rotating rod, followed by a top-layered mixture (5000 each) of Lumavidin-coated #132, Protein A-coupled carboxylated #134, and PNA-coupled Lumavidin-coated #138 beads. Alexa-labeled DNA target and salmon sperm DNA were heat denatured off-line in 2×SSC-Tween 20 hybridization buffer, crash cooled on ice, and amended with biotin-PE, unlabeled rabbit IgG and SSC-Tween 20 to achieve final analyte concentrations of: 5 nM biotin-PE, 14 ng μL⁻¹ rabbit IgG and 20 ng μL⁻¹ DNA in 50 μL (total volume) 2×SSC, 0.02% Tween-20, pH 7.0 hybridization buffer. The triple-analyte mixture was perfused over the microcolumn and washed in 2×SSC-Tween hybridization buffer as outlined for the two-analyte experiments in Table 3. Secondary antibody, wash and elution steps all proceeded as described in Table 3, except that SSC-Tween was used instead of PBS-Tween.

The power of the SI-RSC system, renewable filter method and optically encoded beads is the ability to (potentially) capture and detect multiple analytes (and classes of analyte) simultaneously. Traditional applications of suspension arrays (or optically encoded beads) focus on the detection of multiple species of the same class of analyte (e.g. DNA arrays; protein and antibody arrays). To illustrate the potential for simultaneous recovery and detection of a chemical, protein and nucleic acid analyte from the same input solution, we combined all three model assays into a single renewable filter experiment (Table 7). The specific bead/analyte chemistries used here were not designed for real-world applications. The DNA target, for example, showed significant cross-hybridization to the Lumavidin-coated bead, and the biotin-PE was able to interact with the PNA-coupled bead. Nevertheless, the partitioning of signal in the single analyte, three-bead tests can be used as a reference for the three-analyte, three-bead tests, so that specific (and simultaneous) binding and detection of biotin, rabbit IgG and DNA was detected (although not accurately quantified). For example, the average MFI for the PNA-coupled bead was 1851±190 in the triple-analyte binding experiment, whereas the contribution due to biotin-PE and rabbit IgG (alone) to the PNA-coated bead was only 914±58 and 85±21, respectively. Similar results were obtained for the Lumavidin and Protein-A beads relative to their targeted analytes (Table 7). When an identical experimental series was performed with the mixed column format, however, the contribution of the biotin-PE analyte to the PNA bead signal precluded us from detecting DNA binding to the PNA bead (not shown). This result again illustrates how analyte capture and detection efficiency can be affected by the renewable filter packing strategy.

TABLE 6
Two-analyte capture and detection efficiency^{a} in top-layered and
mixed renewable filters utilizing a 19.9 μm packing layer.

| Beads | | Reagents^{b} | | | Top-Layered | | Mixed | | Student's |
|---|---|---|---|---|---|---|---|---|---|
| Lumavidin | Protein A | 1° Ab | 2° Ab | Biotin-PE^{b} | Lumavidin | Protein A | Lumavidin | Protein A | t-test (P) |
| | | | | | 0.0 ± 0.0 | 0.0 ± 0.0 | 0.0 ± 0.0 | 0.0 ± 0.0 | |
| | ✓ | | | ✓ | 0.0 ± 0.0 | 7.6 ± 0.9 | 0.0 ± 0.0 | 4.4 ± 0.5 | |
| | ✓ | ✓ | | ✓ | 0.0 ± 0.0 | 6.0 ± 1.9 | 0.0 ± 0.0 | 8.4 ± 2.6 | |
| | ✓ | | ✓ | | 0.0 ± 0.0 | 47.2 ± 4.6 | 0.0 ± 0.0 | 18.0 ± 3.4 | |
| ✓ | | | ✓ | | 39.0 ± 31.2 | 0.0 ± 0.0 | 8.4 ± 1.5 | 0.0 ± 0.0 | |
| ✓ | | ✓ | ✓ | | 40.2 ± 7.8 | 0.0 ± 0.02 | 3.6 ± 13.9 | 0.0 ± 0.0 | |
| | ✓ | ✓ | ✓ | | 0.0 ± 0.0 | 2652 ± 82 | 0.0 ± 0.0 | 2796 ± 290 | 0.32 |
| ✓ | ✓ | ✓ | ✓ | | 82.4 ± 8.2 | 2631 ± 1005 | 5.4 ± 29.4 | 3195 ± 91 | <0.001 |
| ✓ | ✓ | | | ✓ | 16830 ± 758 | 4.8 ± 0.41 | 6187 ± 354 | 4.0 ± 0.0 | 0.12 |
| ✓ | ✓ | ✓ | ✓ | ✓ | 15208 ± 226 | 2891 ± 2291 | 5587 ± 254 | 2487 ± 155 | 0.037/0.012^{c} |

^{a}Capture and detection efficiency is reported as the average median fluorescent intensity (± SD) from five replicate experiments and 5000 events. The first 20 positive events were discarded to account for bead carryover between trials.
^{b}Antibodies were perfused at 14.1 ng μL⁻¹ and biotin-PE was perfused at 1 nM, as described in the Methods.
^{c}The Student's t-test between top-layered and mixed packing methods for the mixed analyte capture and detection experiment is for the biotin-PE and antibody analyses, respectively.

TABLE 7
Three-analyte capture and detection efficiency^{a} in the top-
layered renewable filter utilizing a 19.9 μm packing layer.

| Beads^{b} | | | Reagents^{c} | | | | | Top-Layered | | |
|---|---|---|---|---|---|---|---|---|---|---|
| LA | PA | PNA | 1° Ab | 2° Ab | PE | Bg | ssDNA | Lumavidin | Protein A | PNA |
| | | ✓ | ✓ | | ✓ | | | | | 110 ± 17 |
| | | ✓ | | | ✓ | | | | | 1182 ± 244 |
| | | ✓ | | | | | ∓ | | | 158 ± 26 |
| | | ✓ | | | | ✓ | ✓ | | | 162 ± 37 |
| | ✓ | | | | | ✓ | ✓ | | 4.8 ± 0.3 | |
| ✓ | | | | | | ✓ | ✓ | 3120 ± 58 | | |
| ✓ | ✓ | ✓ | ✓ | ✓ | | | | 3205 ± 137 | 1393 ± 82 | 85 ± 21 |
| ✓ | ✓ | ✓ | | | ✓ | | | 9045 ± 182 | 5.0 ± 0.0 | 914 ± 58 |
| ✓ | ✓ | ✓ | | | | ✓ | | 3126 ± 138 | 5.0 ± 0.0 | 138 ± 20 |
| ✓ | ✓ | ✓ | ✓ | ✓ | ✓ | ✓ | | 8798 ± 283 | 1442 ± 73 | 1666 ± 123 |
| ✓ | ✓ | ✓ | ✓ | ✓ | ✓ | ✓ | ✓ | 8076 ± 259 | 1412 ± 106 | 1851 ± 190 |

^{a}Capture and detection efficiency is reported as the average median fluorescent intensity (± SD) from 100 events and five replicate experiments. The first 20 positive events were discarded to account for bead carryover between trials.
^{b}5000 beads of each type were used for each replicate. Bead types are:
LA = Lumavidin #132;
PA = Protein A #134;
PNA = PNA-conjugated #138, as described in the Methods.
^{c}Final analyte concentrations (alone or in combination) were 5 nM biotin-PE, 14 ng μL⁻¹ rabbit IgG and 20 ng μL⁻¹ DNA in 50 μ1 (total volume) 2X SSC, 0.02% Tween-20, pH 7.0 hybridization buffer.

### Closure

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

We claim:

1) an improved method for manipulating small particles in a microfluidic system wherein at least one tolerance of the microfluidic system is greater than the size of the small particles, the improvement comprising providing a layer of large particles, said large particles being sufficiently small enough to capture the small particles, but sufficiently large to not escape through the tolerances within the microfluidic system.

2) The improved method of claim 1 further comprising providing the layer of large particles as a mixture with the small particles in a fluid flow through the microfluidic system.

3) The improved method of claim 1 further comprising first providing the layer of large particles in a fluid flow of the microfluidic system into a region of the microfluidic system having the tolerance, wherein the large particles are stopped by the tolerance and the fluid flow is allowed and to pass through the tolerance, and subsequently providing the small particles in the fluid flow, thereby trapping the small particles above or within the large particles and allowing the fluid flow to pass through the tolerance.

4) The improved method of claim 1 further wherein the small particles are provided as having a diameter of between about 5 and 6 microns.

5) The improved method of claim 1 further wherein the large particles are provided as having a diameter of about 20 microns.

6) The improved method of claim 1 wherein particles are selected from the group consisting of Sr-resin, TRU-resin, TEVA-resin, glass, Sepharose, polystyrene, Tepnel, Qiagen, zirconium, hydroxyapatite, POROS, PEG-PS, PS, and polymeric micro-beads covalently linked to specific oligonucleotide capture probes.

7) An improved method for manipulating small particles having a diameter of between about 5 and 6 microns in a microfluidic system wherein at least one tolerance of the microfluidic system is greater than the size of the small particles, the improvement comprising providing a layer of large particles, said large particles being sufficiently small enough to capture the small particles, but sufficiently large to not escape through the tolerances within the microfluidic system.

8) The improved method of claim 7 further comprising providing the layer of large particles as a mixture with the small particles in a fluid flow through the microfluidic system.

9) The improved method of claim 7 further comprising first providing the layer of large particles in a fluid flow of the microfluidic system into a region of the microfluidic system having the tolerance, wherein the large particles are stopped by the tolerance and the fluid flow is allowed and to pass through the tolerance, and subsequently providing the small particles in the fluid flow, thereby trapping the small particles above or within the large particles and allowing the fluid flow to pass through the tolerance.

10) The improved method of claim 7 further wherein the large particles are provided as having a diameter of about 20 microns.

11) The improved method of claim 7 wherein particles are selected from the group consisting of Sr-resin, TRU-resin, TEVA-resin, glass, Sepharose, polystyrene, Tepnel, Qiagen, zirconium, hydroxyapatite, POROS, PEG-PS, PS, and polymeric micro-beads covalently linked to specific oligonucleotide capture probes.
